(19) United States
(12) Patent Application Publication
(10) Pub. No.: US 2006/0074773 A1
(43) Pub. Date: Apr. 6, 2006

(54) Gift order system and order slip

(75) Inventors: Yoichi Hattori, Tokyo (JP); Koichi Ono, Saitama (JP); Shinichi Fukuda, Saitama (JP)

Correspondence Address: NIXON & VANDERHYE, PC, 901 NORTH GLEBE ROAD, 11TH FLOOR, ARLINGTON, VA, 22203, US

(73) Assignees: YUGEN KAISHA ACCESS, Tokyo (JP); YUGEN KAISHA CREOTEC, Tokyo (JP); KABUSHIKI KAISHA JOY, Tokyo (JP)

(21) Appl. No.: 11/285,063

(22) Filed: Nov. 23, 2005

Related U.S. Application Data
(62) Division of application No. 09/861,868, filed on May 22, 2001.

(30) Foreign Application Priority Data
May 23, 2000 (JP) JP2000-151843

(51) Int. Cl. G06Q 30/00

(52) U.S. Cl. 705/26

(57) ABSTRACT

A gift order system has a memory unit for storing therein desired information such as a name and an address of a client and attribute information of each client including at least a name and an address of a shipped customer and an order history of an item and a price thereof, an order slip forming unit for extracting, from the memory, the client and the attribute information thereof including at least a name and an address of the shipped customer and at least the order history of the item and the price thereof, for indicating extracted information, and for forming an order slip, and a unit for distributing the order slip formed by the order slip forming unit to the client.

### GIFT ORDER SYSTEM AND ORDER SLIP

This application is a divisional of U.S. application Ser. No. 09/861,868 filed May 22, 2001, the entire content of which is expressly incorporated herein by reference.

### BACKGROUND OF THE INVENTION

1. Field of the Invention

The present invention relates to a gift order system for distributing, from shops, e.g., a department store, to a client, an order slip on which an order history of an item and a price thereof is written in predetermined seasons such as gift seasons in summer and winter and for shipping an item which is newly written to the order slip via the shops from the client to a requested customer, and to an order slip.

2. Description of the Related Art

Conventionally, shops such as a department store send, via a hard mail or a home delivery to a client, an item catalogue and an order slip on which a sender as the client and a shipped customer are written during gift seasons in summer and winter. By referring to the item catalogue sent via the hard mail or home delivery, the client selects a gift from the item catalogue, writes order points of the gift to the order slip, and sends the order slip via the hard mail. Alternatively, the client goes to the shop and selects a gift from display items, and a shop assistant writes the order points of the gift to the order slip.

When accepting the order slip, the shop or a product maker of the gift ships an ordered item to a shipped customer. A main description field of the order slip comprises information including a name, an address, a telephone No., etc. of the client as the sender and information including a name, an address, a telephone No., etc. of the shipped customer, which are previously printed. The main description field further comprises a name of an item including an item code to be shipped this time, a price thereof, a shipping charge, and the total amount of money, which are blank fields.

Since the description field of the order slip indicates only the name and the price of the item this time, the client as the sender cannot discriminate the previously shipped item or the price thereof. More specifically, there is a problem in that even if the previously shipped item did not please the shipped customer, the client as the sender cannot determine the previously shipped item and also presents the item again which did not please him/her at the previous shipping time, thereby falling into discredit.

Conventionally, means for distributing the order slip sent to the client is limited to a hard mail or home delivery because the order slip is printed-out paper. There is also a problem that the shipping charge for sending and returning the order slip increases, thus raising costs.

### SUMMARY OF THE INVENTION

Accordingly, in order to solve the above-mentioned problems of the present invention, it is an object of the present invention to provide a gift order system in which a client can determine an order history of a previously presented item and a price thereof this time by using an order slip indicating such an order history in advance and, thus, can select a best item by referring to the order history this time, and to also provide the order slip.

By distributing the order slip indicating the order history of the item and the price thereof to the client via an E-mail, there is also provided a gift order system capable of greatly reducing a conventional postage charge, thereby also reducing costs.

To accomplish the above-mentioned objects, according to the present invention, the gift order system comprises: a memory unit for storing therein desired information such as a name and an address of a client and attribute information of each client including at least a name and an address of a shipped customer and an order history of an item and the price thereof; an order slip forming unit for extracting, from the memory, the client and the attribute information thereof including at least a name and an address of the shipped customer and at least the order history of the item and the price thereof, for indicating extracted information, and for forming an order slip; and means for distributing the order slip formed by the order slip forming unit to the client.

The distributing means may distribute, via a hard mail or a home delivery, the order slip which is printed out by a printer. The item stored in the memory unit may be an item which is shipped in gift seasons in summer and winter.

According to the present invention, an order slip comprises description fields of: at least a name and an address of an ordering client; at least a name and an address of a shipped customer; an item and an address to be shipped this time corresponding to the shipped customer; and an order history of an item and an address corresponding to the shipped customer.

### BRIEF DESCRIPTION OF THE DRAWINGS

FIG. 1 is a block diagram showing a gist ordering system according to the present invention;

FIG. 2 is an explanatory diagram showing forms of information which is stored in a memory unit; and

FIG. 3 is a diagram showing a main portion of an order slip according to the present invention.

### DESCRIPTION OF THE PREFERRED EMBODIMENTS

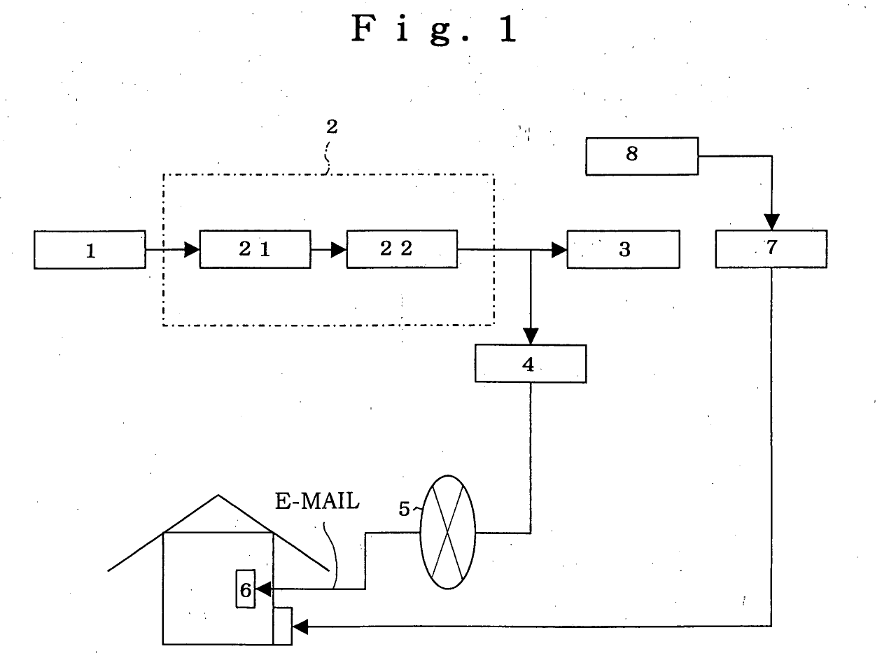

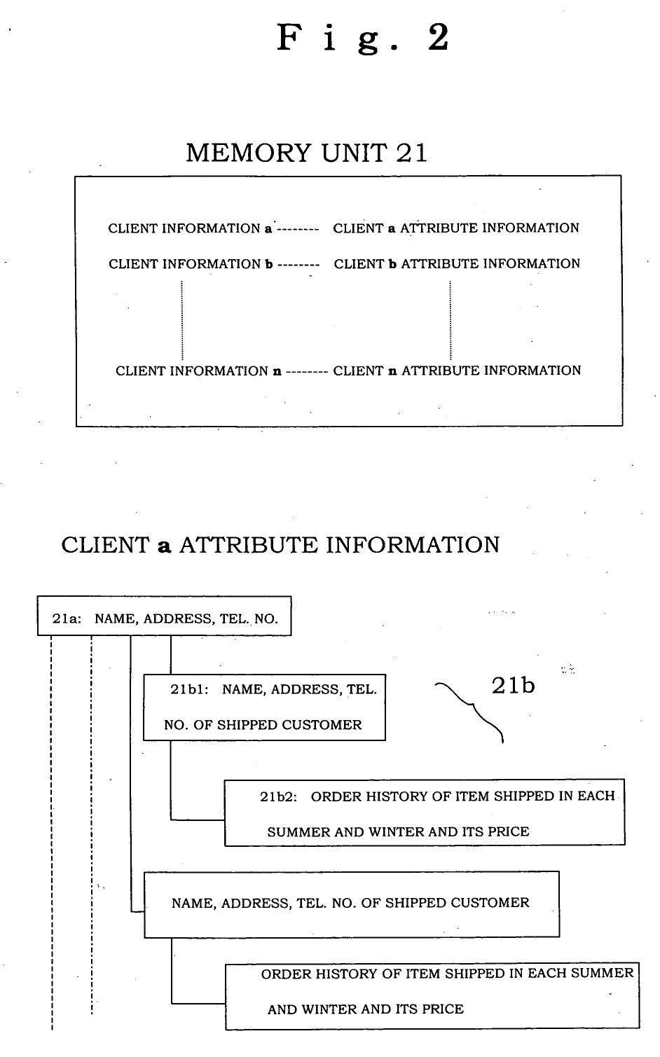

Hereinbelow, a description is given of a gift order system according to the present invention with reference to FIGS. 1 and 2.

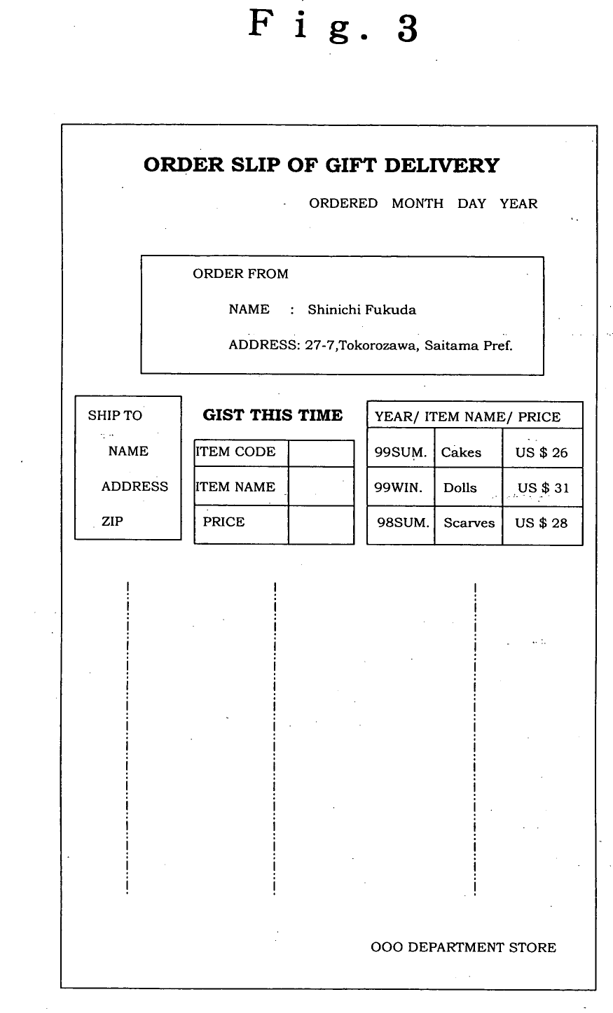

Referring to FIG. 1, reference numeral 1 denotes an input unit such as a keyboard or a barcode reader; and reference numeral 2 denotes a computer comprising a memory unit 21 for storing therein data inputted by the input unit 1 and an order slip forming unit 22 for forming an order slip 8 shown in FIG. 3, which will be described hereinafter, from the data stored in the memory unit 21.

Further, reference numeral 3 denotes a printer for printing out data on the order slip 8 formed by the order slip forming unit 22; reference numeral 4 denotes a modem for transmitting the data formed by the order slip forming unit 22 to the computer 6 of a client via an Internet 5 as an E-mail; and reference numeral 7 denotes a hard mail or delivery carrier for sending the order slip 8 printed out by the printer 3 to the client together with an item catalogue.

Next, a description is given of contents which are stored in the memory unit 21 by the input unit 1 with reference to FIG. 2.

Main contents to be inputted by the input unit 1 are composed of client information 21a such as a name, an address, a telephone No. of the client serving as a sender, and client attribute information 21b such as a shipped customer and a shipped item based on the client information 21a. The client attribute information 21b includes information 21b₁ such as the name, address, E-mail address of the shipped customer and information 21b₂ of the item shipped to each customer and a price thereof.

The client information 21a and the client attribute information 21b are stored and accumulated in the memory unit 21 every shipping an item such as a summer gift or a winter gift. The stored information is processed and stored in the order slip forming unit 22 to be divided into description fields according to a format of the order slip 8 shown in FIG. 3, that is, into a description field 8a of necessary order points such as the name and address of the client, a description field 8b of many necessary order points such as the name and address of the shipped customer, a description field 8c of an item to be shipped this time and a price thereof at positions corresponding to the description field 8b, and a description field 8d of an order history of an item and the price thereof (for example, those in one-previous and two-previous gift seasons in summer and winter) at positions corresponding to the description filed 8b.

As mentioned above, the information stored in the order slip forming unit 22 is printed out by the printer 3 during the gift seasons in summer and winter, and is sent to the client together with the item catalogue, etc. via the hard mail or home delivery. By viewing the order slip 8, the client refers to the description fields in the order history of the item and the price thereof (for example, remembers that the item pleased the shipped customer or did not pleased him/her). Alternatively, the client goes to a shop which sends the order slip 8, determines an item to be present this time together with a shop assistant while seeing a display item, and presents a gift to the shipped customer.

Or, in the case of the client who informed the shop of his E-mail address, the information stored in the order slip forming unit 22 is distributed, as an E-mail, to the client's computer 6 from the modem 4 via the Internet 5. As will be well known, the information can be attached via the E-mail. After viewing the E-mail, the client refers to the description fields in the order history of the item and the price thereof (for example, remembers that the previously presented item pleased him/her or did not), inputs information to the description items in the order slip 8 displayed on a screen to be presented this time, and returns the order slip 8 to the shop as the E-mail, thereby presenting the item as a gift.

As mentioned above, according to the present invention, the order history of the item and the price thereof is indicated in advance in association with the description fields of each shipped customer in the order slip which is distributed from the shop such as a department store during gift seasons in summer and winter. Therefore, the client as the sender can select the item this time by referring to the order history of the item and the price thereof. Accordingly, the client can present an item which is preferable to each shipped customer while remembering that the previously presented item pleased the shipped customer or did not, etc.

Similarly to the conventional manner, the order slip may be sent to the client via the hard mail or home delivery. The order slip can be distributed to the client's computer as a slip via the E-mail and the order slip on which the item and the price thereof can be distributed, thereby realizing E-commerce by using the recent Internet. Accordingly, mail charge and delivery charge are unnecessary and, advantageously, it is preferable to the environmental problems because it is paperless.

1-5. (canceled)

6. A gift order system comprising:
a memory unit for storing therein ordering client information including a name and address of the ordering client and ordering client attribute information including at least a name and an address of a shipped customer to whom the client has previously shipped gifts, an order history corresponding to gift items historically shipped to the customer including gift item names and prices thereof, and information on an outstanding gift item to be shipped to the shipped customer; and
an order slip forming unit operatively connected to the memory unit for receiving information therefrom and for forming an order slip for items to be presented as gifts on a regular basis, said order slip forming unit including a printer for printing on the order slip an ordering client description indicia field located on a front face of the order slip adjacent an upper edge thereof to include at least the name and address of the ordering client, wherein
the order slip forming unit prints at least one group of additional indicia fields including (i) a destination indicia field printed with the indicia of the name and address of the shipped customer, (ii) a gift item indicia field printed with indicia of the information on the outstanding gift item, and (iii) an order history indicia field printed with indicia of the gift items historically shipped to the shipped customer including gift item names and prices thereof, and wherein
the order slip forming unit prints the destination, gift item and order history indicia fields adjacent to one another on a front face of the order form between side edges thereof and below the ordering client description indicia field.

7. The gift order system as in claim 6, further comprising an input unit for inputting information into the memory unit.

8. The gift order system as in claim 6, wherein the input unit includes at least one of a keyboard and a barcode reader.

9. The gift order system as in claim 6, further comprising a transmission unit operatively connected to the order slip forming unit for transmitting an electronic version of the order slip to the client.

10. The gift order system as in claim 7, wherein the transmission unit comprises a modem.
